(19) United States
(12) Patent Application Publication
(10) Pub. No.: US 2025/0324450 A1
(43) Pub. Date: Oct. 16, 2025

(54) SYSTEMS AND METHODS FOR COORDINATING ACCESS POINTS USING SCHEDULE SHARING

(71) Applicant: Meta Platforms Technologies, LLC, Menlo Park, CA (US)

(72) Inventors: Muhammad Kumail Haider, Sunnyvale, CA (US); Guoqing Li, Cupertino, CA (US)

(73) Assignee: Meta Platforms Technologies, LLC, Menlo Park, CA (US)

(21) Appl. No.: 19/076,766

(22) Filed: Mar. 11, 2025

Related U.S. Application Data
(60) Provisional application No. 63/632,847, filed on Apr. 11, 2024.

(51) Int. Cl. H04W 74/04; H04W 74/0816; H04W 84/12

(52) U.S. Cl. CPC H04W 74/04; H04W 74/0816; H04W 84/12

(57) ABSTRACT

In some embodiments, a first access point may include one or more processors and a transceiver for operating in a wireless local area network (WLAN). The one or more processors may be configured to receive, via the transceiver associated with a first basic service set (BSS), information relating to a first schedule from a second access point of the WLAN associated with a second BSS different from the first BSS. The one or more processors may be configured to generate a second schedule based on the information relating to the first schedule. Each of the first schedule and the second schedule may indicate timing information for coordinating between the second access point and the first access point.

### CROSS-REFERENCE TO RELATED APPLICATION

This application claims priority to U.S. Provisional Patent Application No.: 63/632,847 filed on Apr. 11, 2024, which is incorporated by reference herein in its entirety for all purposes.

### FIELD OF DISCLOSURE

The present disclosure is generally related to communications, including but not limited systems and methods of coordinating or sharing schedules between multiple access points (APs).

### BACKGROUND

Artificial reality, such as a virtual reality (VR), an augmented reality (AR), or a mixed reality (MR), provides immersive experience to a user. In one example, a user wearing a head wearable display (HWD) can turn the user's head to one side, and an image of a virtual object corresponding to a location and/or an orientation of the HWD and a gaze direction of the user can be displayed on the HWD to allow the user to feel as if the user is moving within a space of an artificial reality (e.g., a VR space, an AR space, or a MR space). An image of a virtual object may be generated by a computing device communicatively coupled to the HWD. In some embodiments, the computing device may have access to a network.

### SUMMARY

Various embodiments disclosed herein are related to a first access point including one or more processors and a transceiver for operating in a wireless local area network (WLAN). The one or more processors may be configured to receive, via the transceiver associated with a first basic service set (BSS), information relating to a first schedule from a second access point of the WLAN associated with a second BSS different from the first BSS. The one or more processors may be configured to generate a second schedule based on the information relating to the first schedule. Each of the first schedule and the second schedule may indicate timing information for coordinating between the second access point and the first access point.

Various embodiments disclosed herein are related to a method including receiving, by a first access point of a wireless local area network (WLAN) associated with a first basic service set (BSS), information relating to a first schedule from a second access point of the WLAN associated with a second BSS different from the first BSS. The method may include generating, by the first access point, a second schedule based on the information relating to the first schedule. Each of the first schedule and the second schedule may indicate timing information for coordinating between the second access point and the first access point.

Various embodiments disclosed herein are related to a first access point of a wireless local area network (WLAN) associated with a first basic service set (BSS). The first access point may receive information relating to a first schedule from a second access point of the WLAN associated with a second BSS different from the first BSS. The first schedule may indicate timing information for coordinating between the second access point and the first access point. The first access point may generate a second schedule based on the information relating to the first schedule. The second schedule may indicate timing information for transmitting data to, or receiving data from, the first access point.

Various embodiments disclosed herein are related to a method including receiving, by a first access point of a wireless local area network (WLAN) associated with a first basic service set (BSS), information relating to a first schedule from a second access point of the WLAN associated with a second BSS different from the first BSS. The first schedule may include timing information for coordinating between the second access point and the first access point. The method may generating, by the first access point, a second schedule based on the information relating to the first schedule, the second schedule indicating timing information for transmitting data to, or receiving data from, the first access point.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing TWT, according to an example implementation of the present disclosure.

FIG. 5 is a diagram of a system environment including two access points sharing one or more schedules, according to an example implementation of the present disclosure.

FIG. 6 is a flowchart showing a process of sharing one or more schedules between a first access point and a second access point, according to an example implementation of the present disclosure.

FIG. 7 is a flowchart showing a process of sharing one or more schedules between a first access point and a second access point, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Streams of traffic may be characterized by different types of traffic. For instance, an application may be characterized by latency sensitive traffic (e.g., video/voice (VI/VO), real time interactive applications, and the like) or regular traffic (e.g., best effort/background applications (BE/BK)). Latency sensitive traffic may be identifiable, in part, based on its bursty nature (e.g., periodic bursts of traffic), in some embodiments. For instance, video display traffic may be driven by a refresh rate of 60 Hz, 72 Hz, 90 Hz, or 120 Hz. An application and/or device may have combinations of traffic types (e.g., latency sensitive traffic and non-latency sensitive traffic). Further, each stream of traffic for the application and/or device may be more or less spontaneous and/or aperiodic as compared to the other streams of traffic for the application and/or device. Accordingly, traffic may vary according to applications and/or channel rate dynamics.

TWT can be a time agreed/negotiated upon by devices (e.g., access points (APs) and/or stations (STAs)), or specified/configured by one device (e.g., an AP). During the wake time, a first device (e.g., a STA) may be in an awake state (e.g., its wireless communication module/interface is in a fully powered-up ready, or wake state) and is able to transmit and/or receive. When the first device is not awake (e.g., its wireless communication module/interface is in a powered-down, low power, or sleep state), the first device may enter a low power mode or other sleep mode. The first device may exist in the sleep state until a time instance/window as specified by the TWT.

TWT is a mechanism where a set of service periods (SPs) are defined and shared between devices to reduce medium contention and improve the power efficiency of the devices. For example, the first device can wake up periodically (e.g., at a fixed, configured time interval/period/cycle) based on the TWT. The TWT reduces energy consumption of the devices by limiting the awake time and associated power consumption of the devices.

An AP (e.g., AP and/or other device operating as a soft AP/hotspot) may enhance medium access protection and resource reservation by supporting restricted TWT (R-TWT). The R-TWT SPs may be used to deliver latency sensitive traffic and/or any additional frame that supports latency sensitive traffic.

Latency sensitive traffic that is not prioritized (or protected) may degrade a user experience. For example, in an AR context, latency between a movement of a user wearing an AR device and an image corresponding to the user movement and displayed to the user using the AR device may cause judder, resulting in motion sickness.

In one implementation, an image of a virtual object is generated by a remote computing device communicatively coupled to the HWD, and the image is rendered by the HWD to conserve computational resources and/or achieve bandwidth efficiency. In one example, the HWD includes various sensors that detect a location and/or orientation of the HWD and a gaze direction of the user wearing the HWD, and transmits sensor measurements indicating the detected location and gaze direction to a console device (and/or a remote server, e.g., in the cloud) through a wired connection or a wireless connection. The console device can determine a user's view of the space of the artificial reality according to the sensor measurements, and generate an image of the space of the artificial reality corresponding to the user's view. The console device can transmit the generated image to the HWD, by which the image of the space of the artificial reality corresponding to the user's view can be presented to the user. In one aspect, the process of detecting the location of the HWD and the gaze direction of the user wearing the HWD, and rendering the image to the user should be performed within a frame time (e.g., less than 11 ms). Any latency between a movement of the user wearing the HWD and an image displayed corresponding to the user movement can cause judder, which may result in motion sickness and can degrade the user experience.

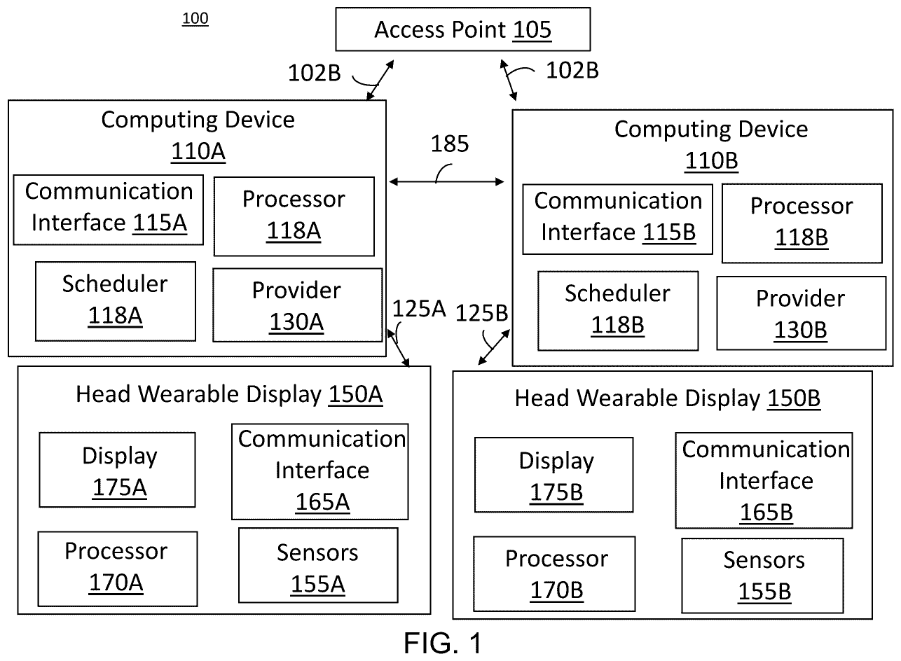

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user's view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155. In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10%) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality. In some embodiments, the processors 118, 170 may configure or cause the communication interfaces 115, 165 to toggle, transition, cycle or switch between a sleep mode and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request R-TWT to transmit latency sensitive traffic using P2P communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110 wish to schedule P2P communication in R-TWT service periods (SPs). The scheduler 118 of the computing device(s) may schedule (or negotiate) the requested R-TWT SP(s). The scheduler 118 of the computing device(s) may also indicate if the SP(s) are requested only for P2P communication (as compared to mixed P2P communication and non-P2P communication).

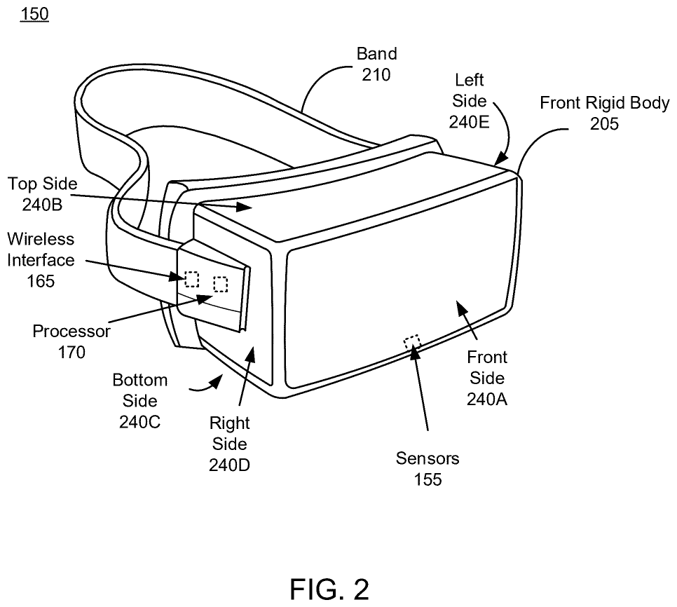

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not visible to the user. In other embodiments, the HWD 150 has a different configuration than shown in FIG. 2. For example, the processor 170, the eye trackers, and/or the sensors 155 may be in different locations than shown in FIG. 2.

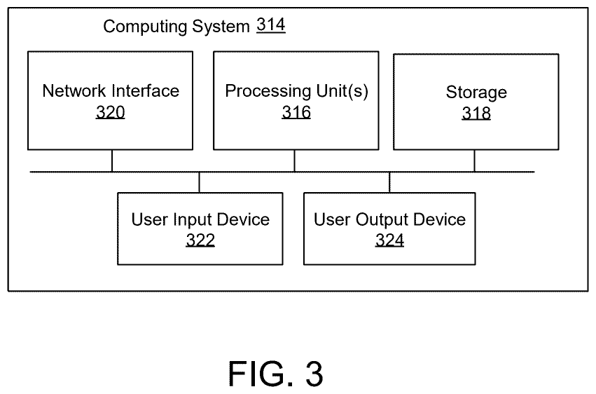

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

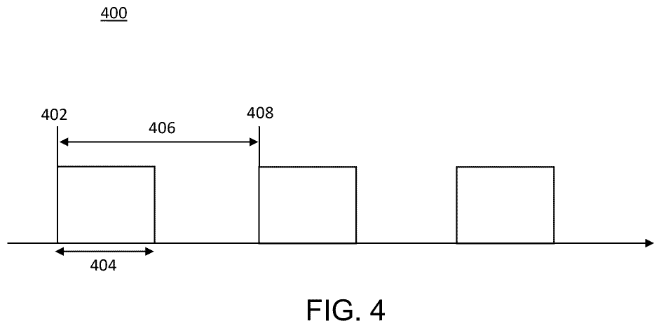

FIGS. 1-2 illustrate devices that communicate traffic streams some of which may be latency sensitive (e.g., those carrying periodic AR/VR information/content). As described herein, the periodic operation of TWT benefits communication of periodic traffic (e.g., latency sensitive traffic) by predictably communicating the periodic traffic. FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406.

A TWT schedule may be communicated and/or negotiated using broadcast TWT (B-TWT) and/or individual TWT (I-TWT) signaling. In some embodiments, to signal I-TWT, TWT schedule information may be communicated to particular (individual) devices using a mode such as a Network Allocation Vector (NAV) to protect the medium access of TWT SPs. In contrast, to signal B-TWT, in some embodiments, a device (such as AP 105) may schedule TWT SPs with other devices (e.g., computing devices 110 and/or HWDs 150) and may share schedule information in beacon frames and/or probe response frames. Sharing schedule information using B-TWT may reduce overhead (e.g., negotiation overhead) as compared to the overhead used when sharing information using I-TWT.

The TWT mechanism may also be used in peer-to-peer (P2P) communication. For example, TWT may be defined for tunneled direct link setup (TDLS) pairs (e.g., non-AP STAs), soft APs (such as computing devices 110) and STAs (such as HWD 150), and/or peer-to-peer group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link.

When P2P communication is established, various channel access rules may govern the P2P communication. An AP assisted P2P trigger frame sequence may reduce the contention/collision associated with TWT (or R-TWT) in P2P communication. Accordingly, a P2P model where a P2P STA (e.g., a HWD 150) is not associated with an infra-basic service set (BSS) AP, may improve P2P communication. Without AP's assistance or coordination, a transmission over the P2P link may collide with another transmission in the BSS. In some embodiments, a reverse direction protocol (RDP) may be enabled for P2P communication. During RDP, when a transmitting STA has obtained a transmit opportunity (TXOP), the transmitting STA may grant permission for the receiving STA to transmit information back to the transmitting STA during the same TXOP. Accordingly, if a TWT setup allows P2P transmission and indicates RDP, the P2P communication can be performed after a triggered frame sequence (e.g., a reverse direction frame exchange). In other embodiments, other protocols may be enabled for P2P communication. In some embodiments, trigger-enabled TWT can reduce the medium contention and/or collisions between UL and DL transmissions. The trigger-enabled TWT may be indicated using a TWT information element (IE).

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

In one aspect, it would be beneficial to coordinate between neighboring APs. For example, coordination between neighboring APs can achieve more efficient operations and suppress overlapping BSS (OBSS) interference. However, there are no existing rules or methods for coordination between neighboring APs.

To address these problems and/or benefits, disclosed herein includes systems, devices and methods for multi-AP schedule coordination, e.g., providing schedules for coordinating between neighboring APs. In some embodiments, systems and/or methods can define rules for schedule coordination between APs in a multi-AP environment. For example, the multi-AP environment can include a plurality of APs associated with one or more basic service sets (BSSs). In some embodiments, a schedule can include timing information for coordinating between APs (e.g., a start time, an interval, or a duration for one AP (of the APs) to use a medium or a channel). In some embodiments, a system can define a schedule for one AP to use a medium or a channel so that during the schedule other APs can avoid using the medium or the channel to suppress interference.

In some embodiments, systems and/or methods can provide rules for multi-AP schedule coordination. In some embodiments, systems and/or methods can perform schedule sharing for coordination between APs. In some embodiments, systems and/or methods can provide coordination between neighboring APs, such as APs across a basic service set (BSS). In some embodiments, systems and/or methods can define schedules and share schedules between different APs or between stations (STAs) that are not part of the same BSS. The shared schedules can include Target Wake Time (TWT) schedules (e.g., B-TWT, I-TWT, R-TWT). In some embodiments, systems and/or methods can define a framework or signaling to share TWT schedules between APs. In some embodiments, the shared information can include other types of schedules besides TWT schedules, allowing for the definition or coordination of other types of schedules (e.g., any schedule or timing information including a start time, an interval and/or a duration). In some embodiments, systems and methods can implement or define different levels of schedule coordination or schedule sharing based on different levels or types of operations an AP can perform using a shared schedule. Multi-AP coordination and schedule sharing can be defined in standards (e.g., Wi-Fi 8 standard which is a mainstream Wi-Fi program that can be widely adopted by the industry).

In some embodiments, an AP (e.g., a sharing AP) can share a schedule for coordination with an AP (e.g., a shared AP), regardless of whether that schedule is being advertised as a TWT schedule. In some embodiments, the shared schedule can be a TWT schedule. In some embodiments, the shared schedule may not be a TWT schedule and can be described by a start time, an interval, and a duration, along with other coordination information enclosed in an Information Element (IE). In some embodiments, the shared schedule may be or include a TWT information element (TWT IE) or any other IE.

In some embodiments, a schedule which one AP share with another AP can be an R-TWT schedule. In some embodiments, the schedule can be described by a different term and/or in a different format from an R-TWT schedule. In some embodiments, an AP may create, generate, or define a schedule to share with another AP. In some embodiments, the shared schedule can describe, fully overlap and/or encompass a non-R-TWT schedule. In some embodiments, the shared schedule can describe, fully overlap and/or encompass a service period that periodically occurs, such as those resulting from Stream Classification Service (SCS) negotiations or triggered access service periods (e.g., SPs of a TWT schedule). For example, during an SCS negotiation, an AP can negotiate (with a STA) classification and/or prioritization of specific internet protocol (IP) flows, ensuring that sensitive traffic such as gaming, voice, and video is given higher priority over bulk data traffic. As a result of SCS negotiations, the AP can determine schedules for the specific IP flows and can share the schedules with another AP.

In some embodiments, an AP may create an R-TWT schedule to fully overlap and/or encompass an individual TWT schedule. In some embodiments, an AP may create, generate, or define a new schedule and share the new schedule with another AP to create a joint schedule (also referred to as “multi-BSS schedule”) for coordinated operation between the respective BSSs of the coordinating APs (e.g., a first BSS of a first AP and a second BSS of a second AP). In such cases, the schedule may not exist nor be advertised in the BSS of either APs, but may become in effect in either or both BSSs (as an R-TWT schedule or any other schedule) in response to the two APs completing negotiations to finalize parameters of the joint/Multi-BSS schedule (e.g., parameters including a start time, an interval, a duration, coordination parameters such as level of coordination, and/or whether an AP performs verification of schedule advertisement for coordination).

In some embodiments, an AP can create, generate or define R-TWT schedules in effect and advertise the R-TWT schedules in the BSS of the AP. In some embodiments, the AP can share these R-TWT schedules for coordination with a neighboring AP to get additional protections and mitigate interference during service periods of the R-TWT schedules. In some embodiments, the AP can share one or more schedules that can be described by a different term and/or in a different format from an R-TWT schedule. In some embodiments, an AP can share all existing R-TWT schedules of the AP for coordination with one or more neighboring APs. In some embodiments, the AP can share only a subset of the R-TWT schedules of the AP for coordination with one or more neighboring APs. In some embodiments, the AP can share the same or different R-TWT schedules with different neighboring APs that the AP coordinates with. For example, a sharing AP can share the same R-TWT schedule with a first shared AP and a second shared AP. The sharing AP can share a first R-TWT schedule with the first shared AP and share a second R-TWT schedule with the second shared AP.

In some embodiments, two APs can perform a handshake process to determine or negotiate a shared schedule (e.g., negotiate to agree to coordinate with each other on the shared schedule). For example, a first AP (also referred to as a “shared AP”) can receive a first schedule from a second AP (also referred to as a “sharing AP”). In response to the first schedule, the first AP can modify the first schedule (e.g., modify a start time of the first schedule) and send a modified schedule (referred to as “second schedule”) to the second AP. In response to the second schedule, the second AP can modify the second schedule (e.g., modify a duration of the second schedule) and send a modified schedule (referred to as “third schedule”) to the first AP. In response to the third schedule, the first AP can agree to coordinate with the second AP on the third schedule and/or start sharing the third schedule with the second AP.

In some embodiments, when the first AP (e.g., a shared AP) agrees to coordinate with the second AP (e.g., a sharing AP) on a (shared) schedule, the first AP may follow certain rules depending on a level of coordination. In some embodiments, the level of coordination can be a coordination parameter which can be included in the shared schedule. In some embodiments, the first AP and the second AP can negotiate the level of coordination (e.g., using a handshake process) separately from the negotiation of the shared schedule. In some embodiments, the level of coordination can be negotiated during schedule coordination agreements between APs (e.g., two or more APs). In some embodiments, in response to the level of coordination being negotiated, the APs can apply the same level of coordination to all schedules shared between the APs or negotiate the level of coordination per schedule via additional signaling mechanisms (e.g., handshake process per schedule).

In some embodiments, each higher level of coordination can encompass rules at that level and all rules below that level. In some embodiments, there can be three levels of coordination including a first level (also referred to as “Level 1”), a second level (also referred to as “Level 2”), or a third level (also referred to as “Level 3”) in an increasing order of levels (e.g., Level 3 is higher than Level 2, and Level 2 is higher than Level 1).

In some embodiments, the first AP (e.g., the shared AP) can determine (e.g., based on the shared schedule) that the level of coordination is Level 1, and devise, create, generate, or define a second schedule (e.g., a non-shared schedule of the first AP) based on the shared schedule. In some embodiments, the first AP can devise, create, generate, or define the second schedule to minimize interference between the shared schedule and the second schedule. For example, the first AP can create the second schedule such that a start time, an interval and/or a duration of the shared schedule does not overlap with (e.g., coincide with, conflict with, concur) a start time, an interval and/or a duration of the second schedule.

In some embodiments, the first AP (e.g., the shared AP) can determine (e.g., based on the shared schedule) that the level of coordination is Level 2, and end (e.g., finish, stop, terminate, close) a transmit opportunity (TXOP) of the first AP at a start time of the shared schedule (e.g., a service period (SP) start boundary of the shared schedule's SPs). In some embodiments, the shared schedule can include or define a plurality of SPs during which the second AP (e.g., sharing AP) can use a medium or a channel.

In some embodiments, the first AP (e.g., the shared AP) can determine (e.g., based on the shared schedule) that the level of coordination is Level 3, and advertise (e.g., announce, broadcast, report, send) one or more shared schedules (e.g., schedules shared by the second AP as the sharing AP) in its own BSS (e.g., BSS of the first AP) as R-TWT schedules. In some embodiments, when the one or more shared schedules are described by a different term and/or in a different format from R-TWT schedules, the first AP (e.g., the shared AP) can convert the one or more shared schedules to R-TWT schedules and advertise the R-TWT schedules in its own BSS (e.g., BSS of the first AP).

In some embodiments, the first AP (e.g., the shared AP) can advertise these shared schedules as its own schedules (e.g., as schedules of the first AP). In some embodiments, the first AP (e.g., the shared AP) can advertise these shared schedules as joint schedules of the first AP and the second AP (e.g., multi-BSS schedules or coordinated schedules of the first AP and the second AP). In some embodiments, a shared schedule advertised by the first AP can be an information element (e.g., TWT IE or other types of IE) that includes one or more subfields indicating whether the shared schedule is a schedule of the first AP or a joint schedule of the first AP and the second AP. In some embodiments, the first AP (e.g., the shared AP) can advertise a shared schedule using one or more beacon frames, one or more management frames, one or more (Re)Association response frames, or one or more TWT setup frames. In some embodiments, the first AP (e.g., the shared AP) can advertise a shared schedule as its own schedule and optionally allow its own stations (e.g., non-AP STAs in the BSS of the first AP) to become members of the shared schedule. In some embodiments, the first AP (e.g., the shared AP) can advertise a shared schedule as a joint schedule and optionally allow its own stations (e.g., non-AP STAs in the BSS of the first AP) to become members of the shared schedule. For example, the first AP (e.g., the shared AP) can advertise a shared schedule as its own schedule and allow its own stations to become members of the schedule being shared. The first AP (e.g., the shared AP) can advertise shared schedules as “OBSS” schedules (as its own schedule or as joint schedules) and not allow its own stations to become members of the schedule being shared.

In some embodiments, a sharing AP (e.g., second AP) can request (e.g., propose, initiate, start, begin) to coordinate with a shared AP (e.g., first AP) on a schedule at Level 2 or higher (e.g., Level 2 or Level 3). In some embodiments, in response to the schedule being requested, the first AP as the shared AP can verify (e.g., confirm, prove, check, determine) whether the schedule being requested for coordination is also being advertised by the second AP in its own BSS. In some embodiments, in response to the schedule being requested, the first AP as the shared AP can check (e.g., confirm, prove, verify, determine) whether B-TWT schedules and/or R-TWT schedules are announced in the second AP's beacon frames.

In some embodiments, when signaling is performed during negotiation of schedule coordination between the APs, whether the shared AP performs such verification can be indicated as a coordination parameter which can be included in the shared schedule. In some embodiments, there may not be such verification requirements. In some embodiments, two APs can create (e.g., devise, generate, define) a joint schedule of the two APs (e.g., a multi-BSS schedule or a coordinated schedule of the two APs) at Level 2 or Level 3, and can verify by checking the other AP's beacons (or management frames, (Re) Association response frames, TWT setup frames, etc.) to determine whether the coordinated schedule is being advertised. For example, the two APs can check the other AP's beacons to determine whether the coordinated schedule is being advertised as an R-TWT schedule. In some embodiments, when a first AP of the two APs determines that the other AP (e.g., second AP) is not advertising the coordinated schedule, the first AP can (1) terminate (e.g., end, finish, cease, stop, cancel) coordination on this coordinated schedule, (2) terminate (e.g., end, finish, cease, stop, cancel) coordination with the second AP completely, and/or (3) tear down (e.g., demolish, knock down, pull down, end, finish, cease, stop, cancel) any coordination agreements with the second AP.

In some embodiments, a first access point may include one or more processors and a transceiver for operating in a wireless local area network (WLAN). The one or more processors may be configured to receive, via the transceiver associated with a first basic service set (BSS), information relating to a first schedule from a second access point of the WLAN associated with a second BSS different from the first BSS. The one or more processors may be configured to generate a second schedule based on the information relating to the first schedule. Each of the first schedule and the second schedule may indicate timing information for coordinating between the second access point and the first access point.

In some embodiments, a first access point may include one or more processors and a transceiver for operating in a wireless local area network (WLAN). The one or more processors may receive, via the transceiver associated with a first basic service set (BSS), information relating to a first schedule from a second access point of the WLAN associated with a second BSS different from the first BSS. The one or more processors may generate a second schedule based on the information relating to the first schedule. Each of the first schedule and the second schedule may indicate timing information for coordinating between the second access point and the first access point.

In some embodiments, the information relating to the first schedule may include at least one of a start time, an interval, or a duration of the first schedule. In some embodiments, the first schedule may include at least one of (1) timing information of a target wake time (TWT) schedule of the second access point or (2) timing information as a result of one or more stream classification service (SCS) negotiations. In some embodiments, the second schedule may be a target wake time (TWT) schedule.

In some embodiments, before receiving the information relating to the first schedule, the one or more processors may be configured to receive, via the transceiver from the second access point, information relating to a third schedule. The one or more processors may be configured to send, via the transceiver to the second access point, information relating to modifying the third schedule, to cause the second access point to generate the information relating to the first schedule based on the information relating to modifying the third schedule. In some embodiments, the one or more processors may be configured to send an announcement of the second schedule.

In some embodiments, a first access point of a wireless local area network (WLAN) associated with a first basic service set (BSS) may receive information relating to a first schedule from a second access point of the WLAN associated with a second BSS different from the first BSS. The first schedule may indicate timing information for coordinating between the second access point and the first access point. The first access point may generate a second schedule based on the information relating to the first schedule. The second schedule may indicate timing information for transmitting data to, or receiving data from, the first access point.

In some embodiments, the information relating to the first schedule may include a level of coordination between the second access point and the first access point. The first access point may generate the second schedule according to the level of coordination. The first access point may end a transmit opportunity (TXOP) at a start time of the first schedule.

In some embodiments, the first access point may send an announcement of the first schedule. The first access point may generate a restricted target wake time (R-TWT) schedule based on the first schedule. The first access point may send, as the announcement of the first schedule, an announcement of the R-TWT schedule. Before sending the announcement of the first schedule, the first access point may determine that the second access point sends an announcement of the first schedule.

In some embodiments, the first access point may determine that the second access point does not send an announcement of the first schedule. The first access point may terminate coordination on the first schedule.

Embodiments in the present disclosure have at least the following advantages and benefits. Embodiments in the present disclosure can provide useful techniques for coordinating timing or schedules between neighboring APs. Such coordination between neighboring APs can achieve more efficient operations and suppress overlapping BSS (OBSS) interference between the neighboring APs.

Second, embodiments in the present disclosure can provide useful techniques for providing a basic framework and/or signaling for APs to coordinate with each other using not only TWT schedules (e.g., I-TWT, B-TWT, R-TWT) but also other type of schedules (e.g., schedules including an IE other than TWT IE) which can be converted to TWT schedules.

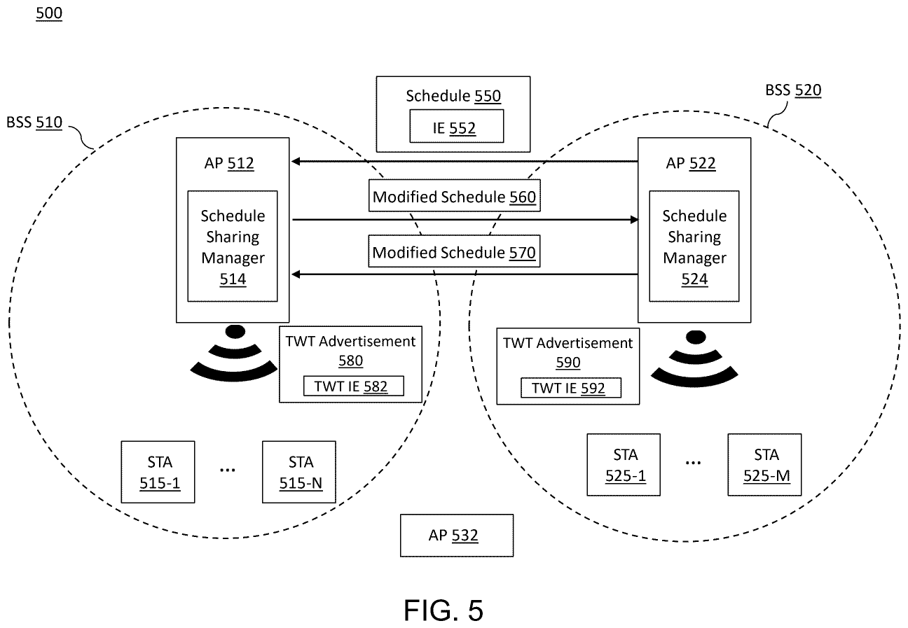

FIG. 5 is a diagram of a system environment 500 including two access points 512, 522 sharing one or more schedules (e.g., schedule 552, 560, 570), according to an example implementation of the present disclosure. Referring to FIG. 5, the first AP 512 can be associated with a first BSS 510 which includes a plurality of stations (e.g., non-AP STAs) 515-1, . . . , 515-N. The second AP 522 can be associated with a second BSS 520 which includes a plurality of stations (e.g., non-AP STAs) 525-1, . . . , 525-N. The first AP 512 can have a schedule sharing manager 514 configured to share one or more schedules with neighboring APs (e.g., AP 522). The schedule sharing manager 514 can be implemented in hardware (e.g., circuitry, processors), firmware, software, or a combination thereof. Similarly, the first AP 522 can have a schedule sharing manager 524 configured to share one or more schedules with neighboring APs (e.g., AP 512). The schedule sharing manager 524 can be implemented in hardware (e.g., circuitry, processors), firmware, software, or a combination thereof.

Referring to FIG. 5, the AP 512 (as a sharing AP) can share a schedule (e.g., a schedule 550 including an information element (IE) 552) for coordination with the AP 522 (as a shared AP), regardless of whether that schedule is being advertised as a TWT schedule. The shared schedule 550 can be a TWT schedule. In some embodiments, the shared schedule 550 may not be a TWT schedule and can be described by a start time, an interval, and a duration, along with other coordination information enclosed in the IE 552. The shared schedule 550 may be or include a TWT information element (TWT IE) or any other IE. The shared schedule 550 can be an R-TWT schedule. The schedule 550 can be described by a different term and/or in a different format from an R-TWT schedule. An AP (e.g., AP 522) may create, generate, or define a schedule to share with another AP (e.g., AP 512). The shared schedule 550 can describe, fully overlap and/or encompass a non-R-TWT schedule. The shared schedule 550 can describe, fully overlap and/or encompass a service period that periodically occurs, such as those resulting from Stream Classification Service (SCS) negotiations or triggered access service periods (e.g., SPs of a TWT schedule). For example, during an SCS negotiation, the AP 522 can negotiate (with a STA 525-1) classification and/or prioritization of specific IP flows, ensuring that sensitive traffic such as gaming, voice, and video is given higher priority over bulk data traffic. As a result of SCS negotiations, the AP 522 can determine schedules for the specific IP flows and can share the schedules with another AP (e.g., AP 512).

The AP 522 can create an R-TWT schedule (as a shared schedule) to fully overlap and/or encompass an individual TWT schedule. The AP 522 may create, generate, or define a new schedule and share the new schedule with another AP (e.g., AP 512) to create a joint schedule (also referred to as “multi-BSS schedule”) for coordinated operation between the respective BSSs of the coordinating APs (e.g., the BSS 510 of the AP 512 and the BSS 520 of the AP 522). In such cases, the schedule may not exist nor be advertised in the BSS of either APs, but may become in effect in either or both BSSs (as an R-TWT schedule or any other schedule) in response to the two APs completing negotiations to finalize parameters of the joint/Multi-BSS schedule (e.g., parameters including a start time, an interval, a duration, coordination parameters such as level of coordination, and/or whether an AP performs verification of schedule advertisement for coordination). For example, the IE 552 can include parameters including (1) a start time of a shared schedule 550, (2) an interval of the shared schedule 550, (3) a duration of the shared schedule 550, and/or (4) coordination parameters such as level of coordination, and/or whether the AP 512 performs verification of schedule advertisement for coordination.

The AP 522 can create, generate or define R-TWT schedules (e.g., TWT IE 592) in effect and advertise the R-TWT schedules in the BSS of the AP 522 (e.g., TWT advertisement 590). The AP 522 can share these R-TWT schedules (e.g., shared schedules 550) for coordination with a neighboring AP 512 to get additional protections and mitigate interference during service periods of the R-TWT schedules 592. The AP 522 can share one or more schedules that can be described by a different term and/or in a different format from an R-TWT schedule. The AP 522 can share all existing R-TWT schedules of the AP 522 for coordination with one or more neighboring APs (e.g., AP 512). The AP 522 can share only a subset of the R-TWT schedules of the AP 522 for coordination with one or more neighboring APs (e.g., AP 512). The AP 522 can share the same or different R-TWT schedules with different neighboring APs (e.g., AP 512, 532) that the AP 522 coordinates with. For example, the AP 522 can share the same R-TWT schedule with the AP 512 and the AP 532. The AP 522 can share a first R-TWT schedule with the AP 512 and share a second R-TWT schedule with the AP 532.

In some embodiments, two APs 512, 522 can perform a handshake process to determine or negotiate a shared schedule (e.g., negotiate to agree to coordinate with each other on the shared schedule). For example, the AP 512 can receive a first schedule (e.g., schedule 550) from the AP 522. In response to the first schedule 550, the AP 512 can modify the first schedule 550 (e.g., modify a start time of the first schedule 550) and send a modified schedule (e.g., a second schedule 560) to the AP 522. In response to the second schedule 560, the AP 522 can modify the second schedule 560 (e.g., modify a duration of the second schedule 560) and send a modified schedule (e.g., third schedule 570) to the AP 512. In response to the third schedule 570, the AP 512 can agree to coordinate with the AP 522 on the third schedule 570 and/or start sharing the third schedule 570 with the AP 522.

When the AP 512 agrees to coordinate with the AP 522 on a (shared) schedule (e.g., schedule 570), the AP 512 may follow certain rules depending on a level of coordination. The level of coordination can be a coordination parameter which can be included in the shared schedule (e.g., IE 552). The AP 512 and the AP 522 can negotiate the level of coordination (e.g., using a handshake process) separately from the negotiation of the shared schedule. The level of coordination can be negotiated during schedule coordination agreements between APs (e.g., two or more APs 512, 522, 532). In response to the level of coordination being negotiated, the APs can apply the same level of coordination to all schedules shared between the APs or negotiate the level of coordination per schedule via additional signaling mechanisms (e.g., handshake process per schedule). Each higher level of coordination can encompass rules at that level and all rules below that level. There can be three levels of coordination including Level 1, Level 2, and Level 3 in an increasing order of levels (e.g., Level 3 is higher than Level 2, and Level 2 is higher than Level 1).

The AP 512 (e.g., the shared AP) can determine (e.g., based on the shared schedule) that the level of coordination is Level 1, and devise, create, generate, or define a second schedule (e.g., a non-shared schedule 582 of the AP 512) based on the shared schedule (e.g., shared schedule 570). The AP 512 can devise, create, generate, or define the second schedule 582 to minimize interference between the shared schedule 570 and the second schedule 582. For example, the AP 512 can create the second schedule 582 such that a start time, an interval and/or a duration of the shared schedule 570 does not overlap with (e.g., coincide with, conflict with, concur) a start time, an interval and/or a duration of the second schedule 582.

The AP 512 (e.g., the shared AP) can determine (e.g., based on the shared schedule 570) that the level of coordination is Level 2, and end (e.g., finish, stop, terminate, close) a transmit opportunity (TXOP) of the first AP at a start time of the shared schedule 570 (e.g., a service period (SP) start boundary of SPs of the shared schedule 570). The shared schedule 570 can include or define a plurality of SPs during which the AP 522 (e.g., sharing AP) can use a medium or a channel.

The AP 512 (e.g., the shared AP) can determine (e.g., based on the shared schedule 570) that the level of coordination is Level 3, and advertise (e.g., announce, broadcast, report, send) one or more shared schedules (e.g., schedules shared by the AP 522 as the sharing AP) in its own BSS (e.g., BSS of the AP 512) as R-TWT schedules (e.g., TWT advertisement 580 of the R-TWT schedule 582). When the one or more shared schedules 570 are described by a different term and/or in a different format from R-TWT schedules, the AP 512 (e.g., the shared AP) can convert the shared schedules 570 to R-TWT schedules (e.g., R-TWT schedules 582) and advertise the R-TWT schedules in its own BSS (e.g., TWT advertisement 580 in the BSS 510 of the AP 512).

The AP 512 (e.g., the shared AP) can advertise these shared schedules (e.g., shared schedules 570) as its own schedules (e.g., TWT schedule 582 of the AP 512). The AP 512 (e.g., the shared AP) can advertise these shared schedules as joint schedules of the first AP and the second AP (e.g., multi-BSS schedules or coordinated schedules of the first AP and the second AP). For example, the advertisement 580 can advertise these shared schedules 570 as joint schedules 582 of the AP 512 and the AP 522. The shared schedule 582 advertised by the AP 512 can be an information element (e.g., TWT IE or other types of IE) that includes one or more subfields indicating whether the shared schedule is a schedule of the AP 512 or a joint schedule of the AP 512 and the AP 522. The AP 512 (e.g., the shared AP) can advertise a shared schedule (e.g., advertisement 580) using one or more beacon frames, one or more management frames, one or more (Re)Association response frames, or one or more TWT setup frames. The AP 512 (e.g., the shared AP) can advertise a shared schedule as its own schedule and optionally allow its own stations (e.g., non-AP STAs 515-1, . . . , 515-N in the BSS 510 of the AP 512) to become members of the shared schedule. The AP 512 (e.g., the shared AP) can advertise a shared schedule as a joint schedule and optionally allow its own stations (e.g., non-AP STAs 515-1, . . . , 515-N) to become members of the shared schedule. For example, the AP 512 (e.g., the shared AP) can advertise a shared schedule as its own schedule and allow its own stations to become members of the schedule being shared. The AP 512 (e.g., the shared AP) can advertise shared schedules as “OBSS” schedules (as its own schedule or as joint schedules) and not allow its own stations to become members of the schedule being shared. In some embodiments, the TWT IE 582 can include one or more subfields indicating whether the advertised schedule is an OBSS schedule.

The AP 522 (as the sharing AP) can request (e.g., propose, initiate, start, begin) to coordinate with the AP 521 (as the shared AP) on a schedule (e.g., schedule 550 or 570) at Level 2 or higher (e.g., Level 2 or Level 3). In response to the schedule being requested, the AP 521 as the shared AP can verify (e.g., confirm, prove, check, determine) whether the schedule being requested for coordination is also being advertised by the AP 522 in its own BSS 520. In response to the schedule being requested, the AP 521 as the shared AP can check (e.g., confirm, prove, verify, determine) whether B-TWT schedules and/or R-TWT schedules are announced in beacon frames of the AP 522 (e.g., announcement or advertisement 590).

In some embodiments, when signaling is performed during negotiation of schedule coordination between the APs 512, 522, whether the shared AP 512 performs such verification can be indicated as a coordination parameter which can be included in the shared schedule (e.g., IE 552). In some embodiments, there may not be such verification requirements. In some embodiments, two APs 512, 522 can create (e.g., devise, generate, define) a joint schedule of the two APs (e.g., a multi-BSS schedule or a coordinated schedule of the two APs) at Level 2 or Level 3, and can verify by checking the other AP's beacons to determine whether the coordinated schedule is being advertised. For example, the two APs 512, 522 can check the other AP's beacons to determine whether the coordinated schedule is being advertised as an R-TWT schedule (e.g., advertisement 580 or advertisement 590). When the AP 512 of the two APs determines that the AP 522 is not advertising the coordinated schedule, the AP 512 can (1) terminate (e.g., end, finish, cease, stop, cancel) coordination on this coordinated schedule, (2) terminate (e.g., end, finish, cease, stop, cancel) coordination with the AP 522 completely, and/or (3) tear down (e.g., demolish, knock down, pull down, end, finish, cease, stop, cancel) any coordination agreements with the AP 522.

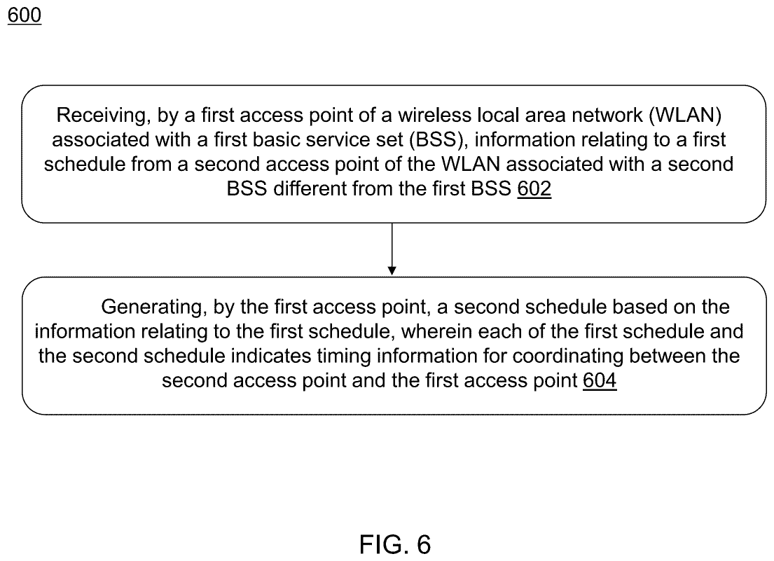

FIG. 6 is a flowchart showing a process 600 of sharing one or more schedules between a first access point and a second access point, according to an example implementation of the present disclosure. In some embodiments, the process 600 is performed by a first access point (e.g., AP 105, AP 512, schedule sharing manager 514) including one or more processors (e.g., processors 316 in FIG. 3) and a transceiver (e.g., network interface 320) associated with the first BSS (e.g., BSS 510) for operating in a wireless local area network (WLAN). In some embodiments, the process 600 is performed by other entities. In some embodiments, the process 600 includes more, fewer, or different steps than shown in FIG. 6.

In one approach, the first access point (e.g., AP 512) may receive 602, via the transceiver associated with the first BSS (e.g., BSS 510), information relating to a first schedule (e.g., schedule 570) from a second access point (e.g., AP 522) of the WLAN associated with a second BSS (e.g., BSS 520) different from the first BSS (e.g., BSS 510).

In some embodiments, the information relating to the first schedule (e.g., IE 552) may include at least one of a start time, an interval, or a duration of the first schedule. In some embodiments, the first schedule may include at least one of (1) timing information of a target wake time (TWT) schedule of the second access point or (2) timing information as a result of one or more stream classification service (SCS) negotiations.

In one approach, the first access point (e.g., AP 512) may generate 604 a second schedule (e.g., schedule 582) based on the information relating to the first schedule (e.g., schedule 570). In some embodiments, each of the first schedule and the second schedule may indicate timing information for coordinating between the second access point (e.g., AP 522) and the first access point (e.g., AP 512). In some embodiments, the second schedule (e.g., schedule 582) may be a target wake time (TWT) schedule (e.g., the schedule 582 is a TWT IE).

In some embodiments, before receiving the information relating to the first schedule (e.g., schedule 570), the first access point (e.g., AP 512) may receive, via the transceiver from the second access point (e.g., AP 522), information relating to a third schedule (e.g., schedule 550). The first access point (e.g., AP 512) may send, via the transceiver to the second access point (e.g., AP 522), information relating to modifying the third schedule (e.g., modified schedule 560), to cause the second access point (e.g., AP 522) to generate the information relating to the first schedule (e.g., schedule 570) based on the information relating to modifying the third schedule (e.g., modified schedule 560). In some embodiments, the first access point (e.g., AP 512) may send an announcement of the second schedule (e.g., advertisement 580 of the schedule 582).

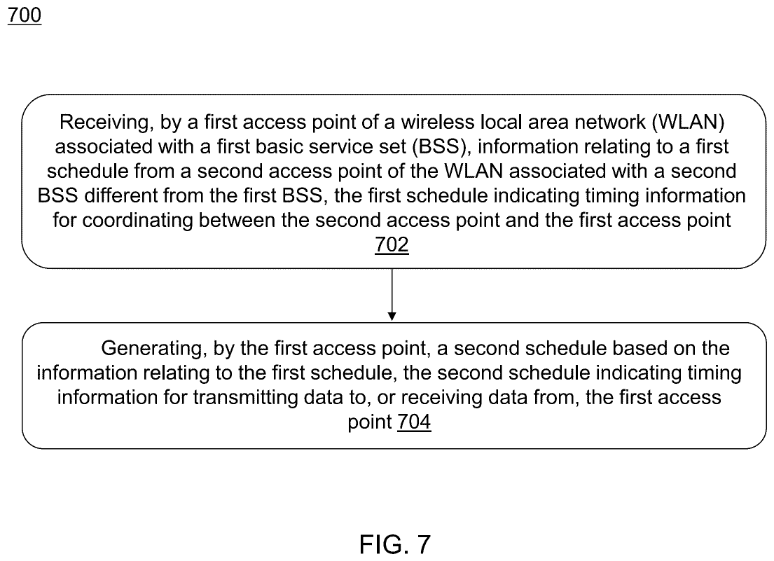

FIG. 7 is a flowchart showing a process 700 of sharing one or more schedules between a first access point and a second access point, according to an example implementation of the present disclosure. In some embodiments, the process 700 is performed by a first access point (e.g., AP 105, AP 512, schedule sharing manager 514) of a wireless local area network (WLAN) associated with a first BSS (e.g., BSS 510 of AP 512) including one or more processors (e.g., processors 316) and a transceiver (e.g., network interface 320). In some embodiments, the process 700 is performed by other entities. In some embodiments, the process 700 includes more, fewer, or different steps than shown in FIG. 7.

In one approach, the first access point (e.g., AP 512) may receive 702 information relating to a first schedule (e.g., schedule 570) from a second access point (e.g., AP 522) of the WLAN associated with a second BSS (e.g., BSS 520) different from the first BSS (e.g., BSS 510). In some embodiments, the first schedule (e.g., schedule 570) may indicate timing information for coordinating between the second access point (e.g., AP 522) and the first access point (e.g., AP 512).

In one approach, the first access point (e.g., AP 512) may generate 704 a second schedule (e.g., TWT IE 582) based on the information relating to the first schedule (e.g., schedule 570). In some embodiments, the second schedule (e.g., TWT IE 582) may indicate timing information for transmitting data to, or receiving data from, the first access point (e.g., AP 512). In other words, the schedule represented by the TWT IE 582 can be a TWT schedule of the AP 512 and is not a joint schedule of the AP 512 and the AP 522.

In some embodiments, the information relating to the first schedule (e.g., IE 552 of the schedule 570) may include a level of coordination between the second access point (e.g., AP 522) and the first access point (e.g., AP 512). The first access point (e.g., AP 512) may generate the second schedule (e.g., TWT IE 582) according to the level of coordination (e.g., Level 1, Level 2, Level 3). For example, in response to determining that the level of coordination is Level 2, the first access point (e.g., AP 512) may end a transmit opportunity (TXOP) at a start time of the first schedule (e.g., start time of the schedule 570). In response to determining that the level of coordination is Level 3, the first access point (e.g., AP 512) may send an announcement (e.g., TWT advertisement 580) of the first schedule. The first access point may generate a restricted target wake time (R-TWT) schedule (e.g., TWT IE 582) based on the first schedule (e.g., schedule 570). For example, if the schedule 570 is not a TWT schedule, the AP 512 can convert the schedule 570 to an R-TWT schedule (e.g., TWT IE 582). The first access point (e.g., AP 512) may send, as the announcement of the first schedule, an announcement of the R-TWT schedule (e.g., advertisement 580).

Before sending the announcement (e.g., advertisement 580) of the first schedule, the first access point may determine that the second access point (e.g., AP 522) sends an announcement (e.g., advertisement 590) of the first schedule as a verification process. In some embodiments, the first access point (e.g., AP 512) may determine that the second access point (e.g., AP 522) does not send an announcement of the first schedule, and may terminate coordination on the first schedule (e.g., schedule 570).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a first access point of a wireless local area network (WLAN) associated with a first basic service set (BSS), information relating to a first schedule from a second access point of the WLAN associated with a second BSS different from the first BSS; and
generating, by the first access point, a second schedule based on the information relating to the first schedule,
wherein each of the first schedule and the second schedule indicates timing information for coordinating between the second access point and the first access point.

2. The method of claim 1, wherein the information relating to the first schedule includes at least one of a start time, an interval, or a duration of the first schedule.

3. The method of claim 1, wherein the second schedule is a target wake time (TWT) schedule.

4. The method of claim 1, further comprising:
generating, by the second access point, the first schedule to include timing information of a target wake time (TWT) schedule of the second access point.

5. The method of claim 1, further comprising:
generating, by the second access point, the first schedule based on a result of one or more stream classification service (SCS) negotiations.

6. The method of claim 1, further comprising:
before receiving the information relating to the first schedule, receiving, by the first access point from the second access point, information relating to a third schedule;
sending, by the first access point to the second access point, information relating to modifying the third schedule; and
generating, by the second access point, the information relating to the first schedule based on the information relating to modifying the third schedule.

7. The method of claim 1, further comprising:
sending, by the first access point, an announcement of the second schedule.

8. A method, comprising:
receiving, by a first access point of a wireless local area network (WLAN) associated with a first basic service set (BSS), information relating to a first schedule from a second access point of the WLAN associated with a second BSS different from the first BSS, the first schedule indicating timing information for coordinating between the second access point and the first access point; and
generating, by the first access point, a second schedule based on the information relating to the first schedule, the second schedule indicating timing information for transmitting data to, or receiving data from, the first access point.

9. The method of claim 8, wherein
the information relating to the first schedule includes a level of coordination between the second access point and the first access point, and
the first access point generates the second schedule according to the level of coordination.

10. The method of claim 8, further comprising:
ending, by the first access point, a transmit opportunity (TXOP) at a start time of the first schedule.

11. The method of claim 8, further comprising:
sending, by the first access point, an announcement of the first schedule.

12. The method of claim 11, further comprising:
generating, by the first access point, a restricted target wake time (R-TWT) schedule based on the first schedule; and
sending, by the first access point as the announcement of the first schedule, an announcement of the R-TWT schedule.

13. The method of claim 12, further comprising:
before sending the announcement of the first schedule, determining, by the first access point, that the second access point sends an announcement of the first schedule.

14. The method of claim 8, further comprising:
determining, by the first access point, that the second access point does not send an announcement of the first schedule; and
terminating, by the first access point, coordination on the first schedule.

15. A first access point, comprising:
a transceiver for operating in a wireless local area network (WLAN); and
one or more processors configured to:
receive, via the transceiver associated with a first basic service set (BSS), information relating to a first schedule from a second access point of the WLAN associated with a second BSS different from the first BSS; and
generate a second schedule based on the information relating to the first schedule,
wherein each of the first schedule and the second schedule indicates timing information for coordinating between the second access point and the first access point.

16. The first access point of claim 15, wherein the information relating to the first schedule includes at least one of a start time, an interval, or a duration of the first schedule.

17. The first access point of claim 15, wherein the first schedule includes at least one of (1) timing information of a target wake time (TWT) schedule of the second access point or (2) timing information as a result of one or more stream classification service (SCS) negotiations.

18. The first access point of claim 15, wherein the second schedule is a target wake time (TWT) schedule.

19. The first access point of claim 15, wherein the one or more processors are configured to:
before receiving the information relating to the first schedule, receive, via the transceiver from the second access point, information relating to a third schedule; and
send, via the transceiver to the second access point, information relating to modifying the third schedule, to cause the second access point to generate the information relating to the first schedule based on the information relating to modifying the third schedule.

20. The first access point of claim 15, wherein the one or more processors are configured to:
send an announcement of the second schedule.
